(19) United States
(12) Patent Application Publication
(10) Pub. No.: US 2020/0296340 A1
(43) Pub. Date: Sep. 17, 2020

(54) COLOR CONVERSION METHOD, COLOR CONVERSION DEVICE, AND DISPLAY DEVICE

(71) Applicant: SEIKO EPSON CORPORATION, Tokyo (JP)

(72) Inventor: Fumio KOYAMA, Shiojiri-shi (JP)

(73) Assignee: SEIKO EPSON CORPORATION, Tokyo (JP)

(21) Appl. No.: 16/816,359

(22) Filed: Mar. 12, 2020

(30) Foreign Application Priority Data
Mar. 13, 2019 (JP) 2019-045705

(51) Int. Cl. H04N 9/31

(52) U.S. Cl. CPC H04N 9/3182; H04N 9/3155; H04N 9/3197

(57) ABSTRACT

The color conversion method may include the steps of taking a color required to be changed as a designated color out of input colors included in a display image to be displayed using an input image signal, taking a conversion color to be designated as an output color after changing the designated color, and performing color conversion of the designated color into the conversion color out of the input colors to output an output image signal for displaying the display image using the input image signal on which the color conversion was performed.

The present application is based on, and claims priority from JP Application Serial Number 2019-045705, filed Mar. 13, 2019, the disclosure of which is hereby incorporated by reference herein in its entirety.

### BACKGROUND

### 1. Technical Field

The present disclosure relates to a color conversion method, a color conversion device, and a display device.

### 2. Related Art

In the past, there has been known a color conversion device for converting color signals such as RGB signals input from the outside using a three-dimensional look-up table (hereinafter also referred to as 3D-LUT).

A user needs to change some of the colors in accordance with convenience in some cases when the user checked an image projected by a display device such as a projector. It requires a large amount of processing for entirely changing the 3D-LUT large in data amount to change some of the colors. Therefore, there has been demanded a method of converting some of the colors of an output image with a simple method.

### SUMMARY

According to an aspect of the present disclosure, there is provided a color conversion method. The color conversion method may include the steps of taking a color required to be changed as a designated color out of input colors included in a display image to be displayed using an input image signal, taking a conversion color to be designated as an output color after changing the designated color, and performing color conversion of the designated color into the conversion color out of the input colors to output an output image signal for displaying the display image using the input image signal on which the color conversion was performed.

### BRIEF DESCRIPTION OF THE DRAWINGS

FIG. 1 is a block diagram showing a function of a projector as an example of a display device.

FIG. 2 is a block diagram particularly showing a configuration of a simple color gamut conversion circuit.

FIG. 3 is a flowchart showing a color conversion method to be performed by the simple color gamut conversion circuit.

FIG. 4 is an explanatory diagram schematically showing a selection screen for a designated color.

FIG. 5 is an explanatory diagram schematically showing a selection screen for a conversion color.

FIG. 6 is an explanatory diagram schematically showing a color conversion process in a three-dimensional color space.

FIG. 7 is an explanatory diagram showing a correspondence relationship of a conversion from an input image signal to an output image signal.

FIG. 8 is an explanatory diagram schematically showing a display image in a state on which a color conversion process has been performed.

FIG. 9 is a flowchart showing a color conversion method according to a second embodiment.

FIG. 10 is an explanatory diagram showing a correspondence relationship of a conversion in the second embodiment.

### DESCRIPTION OF EXEMPLARY EMBODIMENTS

### A. First Embodiment

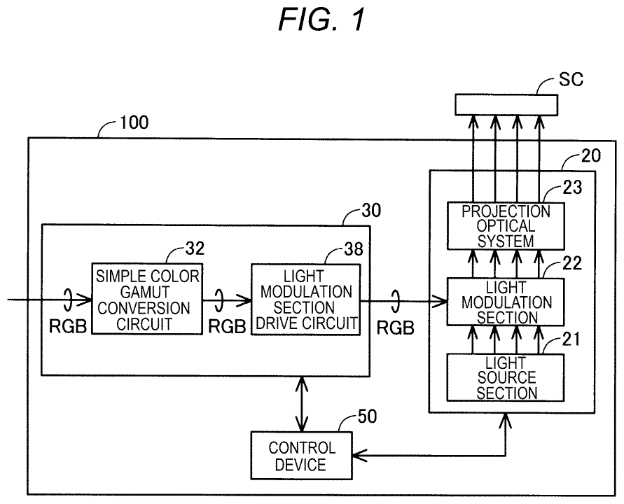

FIG. 1 is a block diagram showing a function of a projector 100 as an example of a display device. The projector 100 is coupled to an image supply device not shown, and projects a display image to form the display image on a screen SC using input image data input from the image supply device. The projector 100 is provided with a control device 50 which is constituted by a memory and a CPU, and performs overall control of the whole of the projector 100, a color conversion device 30 for processing the input image data under the control by the control device 50, and a projection device 20 for projecting the display image on the screen SC. In the present embodiment, a function of each section of the control device 50 is realized by a processor of the control device 50 executing a computer program. A function of each section of the color conversion device 30 is realized by a hardware circuit such as an FPGA (field-programmable gate array). Further, it is possible to realize some of the functions of the control device 50 with a hardware circuit, and it is possible to realize some of the functions of the color conversion device 30 with the processor.

The projection device 20 is provided with a light source section 21, a light modulation section 22 for modulating the light emitted by the light source section 21, and a projection optical system 23 for collecting and diffusing the light modulated by the light modulation section 22 to project the light on the screen SC. The light source section 21 is provided with a light source consisting of a xenon lamp, a super-high pressure mercury lamp, an LED, or the like. The light source section 21 is provided with a drive circuit for supplying the light source with a drive current in accordance with the control by the control device 50 to put ON/OFF the light source. Further, the light source section 21 is provided with a reflector for guiding the light emitted by the light source to the light modulation section 22, and a lens group not shown for enhancing the optical characteristics of the projection light. It is possible for the light source section 21 to be provided with a polarization plate, a dimming element for reducing an amount of the light emitted by the light source on a path to the light modulation section 22, and so on.

The light modulation section 22 is provided with a liquid crystal panel or a digital mirror device (DMD), and modulates the light emitted by the light source section 21. For example, the light modulation section 22 is provided with three transmissive liquid crystal panels corresponding respectively to the colors of RGB, and these transmissive liquid crystal panels are driven by a light modulation section drive circuit 38 described later. Besides the configuration provided with the three transmissive liquid crystal panels, the light modulation section 22 can be provided with, for example, a configuration of being provided with three DMD, or a configuration in which a single transmissive liquid crystal panel or a single DMD, and a color wheel combined with each other. The projection optical system 23 is provided with a prism for combining the three colors of R, G and B of modulated light modulated by the light modulation section 22, a lens group for imaging the projection image combined by the prism on the screen SC, and so on.

In the present embodiment, the input image data is input from a personal computer as the image supply device to the projector 100. The input image data can be input from external equipment such as an image player or a digital camera, or can also be read out from a storage device provided to the projector 100. The image signal input to the projector 100 can also be image data of a moving image besides image data of a still image.

The color conversion device 30 performs the conversion from the designated color to the conversion color in accordance with the designated color designated by the user and the conversion color out of the input image data input from the image supply device, and outputs the result as an image control signal for driving the light modulation section 22. The color conversion device 30 is provided with a simple color gamut conversion circuit 32 and the light modulation section drive circuit 38. The input image data input to the color conversion device 30 is input to the simple color gamut conversion circuit 32 as the image signal via an image input interface not shown. The image input interface can be provided with a connector to be coupled to the image supply device and an interface circuit, or it is also possible to provide the connector and the interface circuit instead of the image input interface. Further, the image input interface can be provided with a configuration capable of inputting an analog image signal, or it is also possible for the image input interface to be provided with an A/D converter for converting the analog image signal into a digital image data and so on to output the digital image data thus converted to a signal processing section. It is also possible to provide the signal processing section for performing a variety of types of image processing such as a resolution conversion process, a frame rate conversion process, a 3D image conversion process, a distortion correction process, and a zooming process disposed between the image input interface and the simple color gamut conversion circuit 32.

The simple color gamut conversion circuit 32 performs a process of performing a color conversion from the designated color included in the input image signal to the conversion color. The input image signal to be input to the simple color gamut conversion circuit 32 is an RGB input image signal constituted by respective image signal components of R (red), G (green), and B (blue) in the present embodiment. The input image signal can be, for example, a YUV image signal constituted by Y (a luminance signal), U (a first color-difference signal), and V (a second color-difference signal), or can also be a YCbCr image signal or a YPbPr image signal. It is also possible to provide, for example, a color adjustment circuit between the image input interface and the simple color gamut conversion circuit 32, the color adjustment circuit performing a conversion into an HLS image signal consisting of H (hue), S (saturation), and L (luminance) components to perform a color adjustment.

The simple color gamut conversion circuit 32 outputs the image signal on which the color conversion process has been performed to the light modulation section drive circuit 38. In the present embodiment, the image signal output to the light modulation section drive circuit 38 includes the respective image signal components of R, G, and B. The light modulation section drive circuit 38 drives the light modulation section 22 based on the image signal input from the simple color gamut conversion circuit 32. More specifically, the light modulation section drive circuit 38 drives the liquid crystal display panels of the light modulation section 22 based on the image control signal input, and thus draws the images on the liquid crystal display panels. The projection device 20 functions as a display section for projecting the display image on the screen SC in accordance with the images drawn on the liquid crystal display panels.

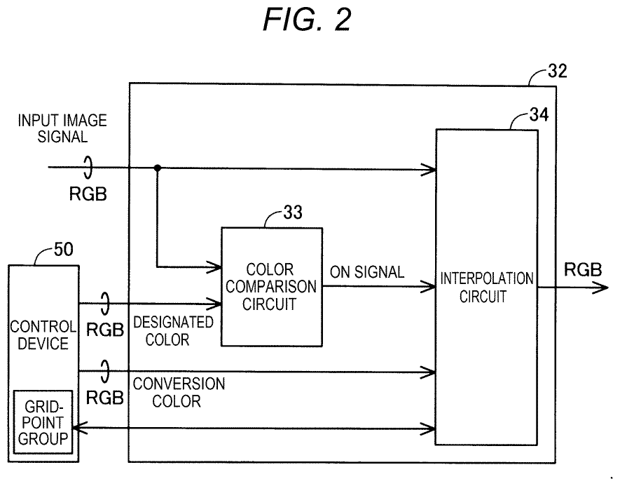

Then, a configuration of simple color gamut conversion circuit 32 will be described using FIG. 2. FIG. 2 is a block diagram particularly showing a configuration of the simple color gamut conversion circuit 32. The simple color gamut conversion circuit 32 is provided with a color comparison circuit 33 and an interpolation circuit 34. The input image signal input from the image supply device via the image input interface is input to the color comparison circuit 33 and the interpolation circuit 34.

The color comparison circuit 33 determines whether or not the designated color is included in the input image signal by comparing an RGB value of the designated color and RGB values corresponding to the colors included in the input image signal to each other. The designated color represents a color a change of which is requested by an instruction of the user out of the input colors included in the display image to be displayed using the input image signal by the projector 100. The display image can also be an image to be displayed by a variety of devices for displaying an image based on the image signal such as a personal computer, a printer, or a liquid crystal monitor besides the projector 100. In the present embodiment, the designated color is arbitrarily selected by the user of the personal computer as the image supply device to be coupled to the projector 100. The designated color is input to the color comparison circuit 33 as the RGB value via the control device 50. When the color comparison circuit 33 has detected the RGB value of the designated color in the input image signal, the color comparison circuit 33 outputs an ON signal for changing the RGB value of the designated color to the interpolation circuit 34.

The interpolation circuit 34 converts only the designated color out of the colors included in the input image signal into the conversion color. The conversion color is a color to be designated as an output color after changing the designated color, and is arbitrarily selected by the user of the personal computer as the image supply device, and is input to the interpolation circuit 34 as the RGB value via the control device 50 similarly to the designated color in the present embodiment. The interpolation circuit 34 detects the RGB value of the designated color based on the ON signal input from the color comparison circuit 33, and then converts only the RGB value corresponding to the designated color out of the input image signal into the RGB value corresponding to the conversion color. The RGB values corresponding to other colors than the designated color out of the input image signal are output to the light modulation section drive circuit 38 while being kept at the RGB values as input.

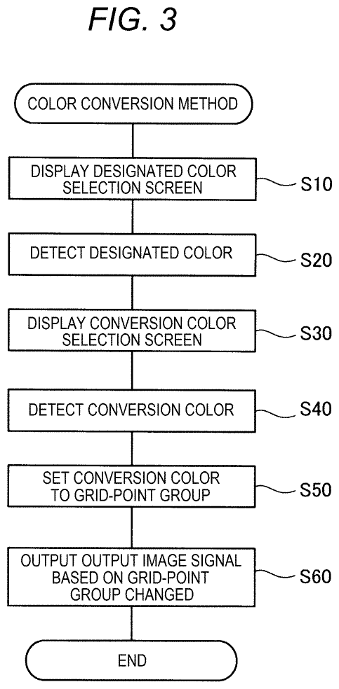

Then, the details of the color conversion method to be performed by the simple color gamut conversion circuit 32 will be described using FIG. 3 through FIG. 8. FIG. 3 is a flowchart showing the color conversion method to be performed by the simple color gamut conversion circuit 32 of the color conversion device 30. The present flow starts in response to the control device 50 receiving the instruction of changing the designated color in accordance with, for example, an operation of the projector 100 by the user.

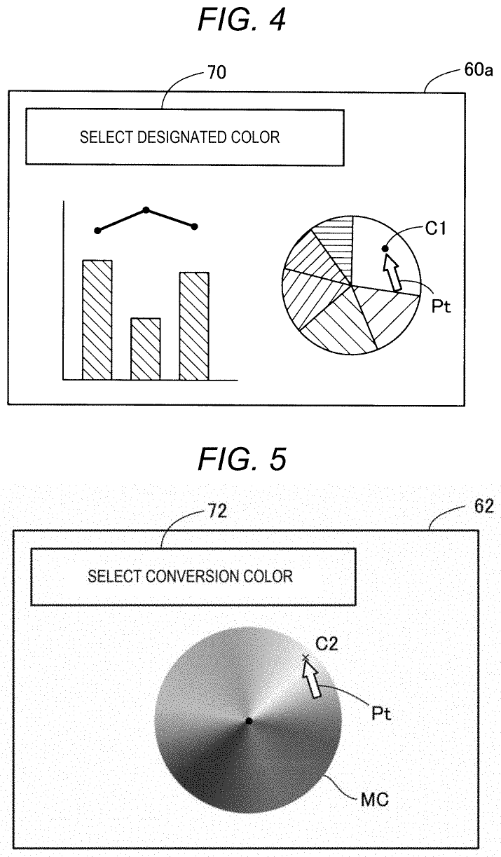

In the step S10, the control device 50 displays a selection screen for the designated color as the display image of the projector 100. FIG. 4 is an explanatory diagram schematically showing the selection screen for the designated color. In the present embodiment, an adjustment screen 60a is an image obtained by the control device 50 adding an image 70 and a cursor Pt to the display image projected on the screen SC by the projector 100 based on the arbitrary input image data input from the personal computer. It is possible for the user to select a color on the display image as the designated color while visually recognizing the color on the display image using the adjustment screen 60a. The user operates the cursor Pt via the control device 50 with the operation of the personal computer or the projector 100 to move the cursor Pt to a desired color on the adjustment screen 60a to select the designated color. In the example shown in FIG. 4, it is assumed that the color C1 in the adjustment screen 60a is selected. Hereinafter, the color C1 is also referred to as the designated color C1. In the step S20, the RGB signal corresponding to the designated color C1 thus selected is input to the color comparison circuit 33 via the control device 50, and the color comparison circuit 33 detects the designated color C1. The color comparison circuit 33 outputs the ON signal corresponding to the designated color C1 thus detected to the interpolation circuit 34.

In the step S30, the control device 50 having received the input of the designated color displays the selection screen for the conversion color as the display image of the projector 100. FIG. 5 is an explanatory diagram schematically showing the selection screen for the conversion color. A conversion color selection screen 62 is a display image including a hue circle MC, an image 72, and the cursor Pt. The conversion color selection screen 62 is projected on the screen SC by the projector 100 as the adjustment screen including the selection screen for the conversion color. It is possible for the user to select a color on the display image as the conversion color while visually recognizing the color on the display image using the conversion color selection screen 62. The user operates the cursor Pt to move the cursor Pt to a desired color in the hue circle MC on the conversion color selection screen 62 to select the conversion color. The hue circle MC can have a simple configuration of displaying only colors which can be changed. It is possible for the conversion color selection screen 62 to use index colors using a color pallet instead of the hue circle MC, or to display a plurality of colors using an arbitrary method. In the example shown in FIG. 5, it is assumed that the color C2 in the hue circle MC in the conversion color selection screen 62 is selected. Hereinafter, the color C2 is also referred to as the conversion color C2. In the step S40, by inputting the RGB signal corresponding to the conversion color C2 thus selected to the interpolation circuit 34 via the control device 50, the interpolation circuit 34 detects the conversion color C2.

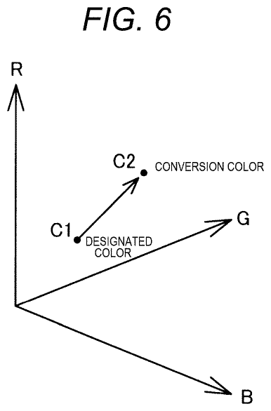

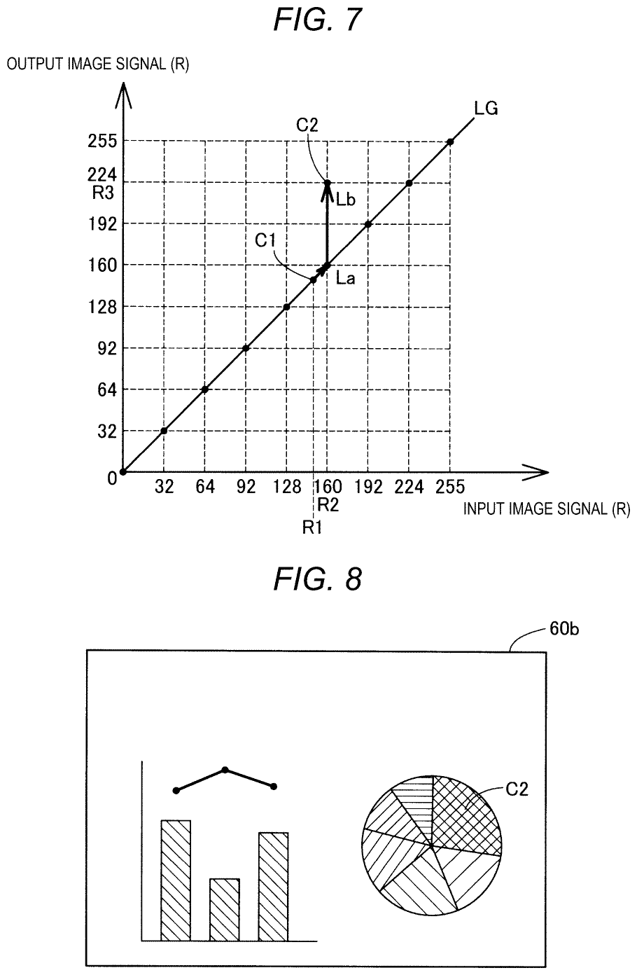

In the step S50, the interpolation circuit 34 having received the ON signal corresponding to the designated color C1 and the conversion color C2 performs a process for setting the conversion color C2 in a grid-point group. Here, a process of setting the conversion color C2 in the grid-point group performed by the simple color gamut conversion circuit 32 will be described using FIG. 6 and FIG. 7. FIG. 6 is an explanatory diagram schematically showing a color conversion process with the simple color gamut conversion circuit 32 in a three-dimensional color space. As shown in FIG. 6, the designated color C1 is changed to the RGB value represented in the three-dimensional color space to thereby be converted into the conversion color C2.

FIG. 7 is an explanatory diagram showing a correspondence relationship of a conversion from the input image signal to the output image signal. In FIG. 7, there is only shown the color conversion in the R value in the three-dimensional color space shown in FIG. 6 for the sake of convenience of explanation. The horizontal axis in the drawing represents the R value of the input image signal expressed in the grayscale from 0 through 255, and the vertical axis represents the R value of the output image signal expressed in the grayscale from 0 through 255. The correspondence relationship shown in FIG. 7 is a so-called conversion map for converting the input image signal into the output image signal, and is stored in the memory of the control device 50. The color conversion process performed in each of the G value and the B value other than the R value is substantially the same as the color conversion process performed in the R value, and therefore, the description thereof will be omitted.

In the present embodiment, in the color conversion process by the interpolation circuit 34, there is used a plurality of grid-points discretized in the color space. The grid-pints are discretized into pixel values by 32 gray levels such as 0, 32, 64, . . . , 255 out of the R value in the 256 gray levels expressed by 0 through 255 shown in FIG. 7. The grid-points are not limited to the values by 32 gray levels, but can arbitrarily be set to values by 2 gray levels, 16 gray levels, 64 gray levels and so on. Among the plurality of grid-points, the grid-points representing the corresponding relationship in the R value of the output image signal with respect to the R value of the input image signal are also referred to as the grid-point group. In other words, the grid-point group defines an output color with respect to an input color. FIG. 7 shows a grid-point group LG conceptually representing the grid-point group. The interpolation circuit 34 performs the color conversion process in three dimensions based on the RGB value based on the grid-point group LG developed in a reticular pattern in the three-dimensional color space represented by the RGB value.

The grid-point group LG on a straight line shown in FIG. 7 represents the state of initial setting of the correspondence relationship of the R value of the output image signal with respect to the R value of the input image signal, and shows the correspondence relationship in which the R value of the input image signal and the R value of the output image signal correspond to each other in a one-to-one basis. The grid-point group LG is rewritten by the simple color gamut conversion circuit 32, and is reset to the initial setting, for example, every start-up of the projector 100.

The interpolation circuit 34 sets the R value included in the designated color C1 as the R value of the input image signal, and sets the R value included in the conversion color C2 as the R value of the output image signal. In the example shown in FIG. 7, the R value of the designated color C1 is assumed as an input pixel value R1 (150 in the drawing). It is assumed that the input pixel value R1 is not included in the grid-points of the grid-point group LG. On the other hand, the R value of the conversion color C2 is assumed as an output pixel value R3 (224 in the drawing), and it is assumed that the output pixel value R3 is the R value of the grid-point in the three-dimensional color space.

In the present embodiment, since the input pixel value R1 of the designated color C1 thus obtained is not included in the grid-points on the grid-point group LG, the interpolation circuit 34 approximates the input pixel value R1 to the grid-point to be the nearest neighbor out of the grid-points included in the grid-point group LG. More specifically, the interpolation circuit 34 approximates the input pixel value R1 to an input pixel value R2 as the grid-point to be the nearest neighbor of the input pixel value R1 using a nearest neighbor interpolation also cal led a nearest neighbor method. In contrast, when the pixel value of the designated color thus obtained is included in the grid-points on the grid-point group LG, the interpolation circuit 34 uses that pixel value.

Then, the interpolation circuit 34 replaces a grid-point La having the input pixel value R2 thus approximated as the input image signal with a grid-point Lb having an output pixel value R3 corresponding to the conversion color C2 as the output image signal out of the grid-point group LG. It should be noted that the grid-point Lb is a grid-point corresponding to the conversion color C2, and is designated as another grid-point not included in the grid-point group LG. Thus, when the input color having the input pixel value R2 is included in the input image signal, for example, there is performed the color conversion to the output image signal including the output color having the output pixel value R3 corresponding to the conversion color C2. Further, in the present embodiment, even when the R value of the input image signal is not included in the grid-points of the grid-point group LG as in the case of the designated color C1, the approximation to the input pixel value R2 as the grid-point on the grid-point group LG is performed using the nearest neighbor interpolation to perform the conversion into the output pixel value R3 corresponding to the conversion color C2. In other words, the input color included in the color gamut in the vicinity of the grid-point La is converted into the conversion color C2. It is also possible to convert only the input color of the grid-point La into the conversion color C2. As described above, in the step S50, the interpolation circuit 34 rewrites the grid-point La to be the nearest neighbor of the designated color C1 out of the grid-point group LG so as to become the grid-point Lb corresponding to the conversion color C2, and then stores the grid-point group LG thus rewritten in the memory of the control device 50.

In the step S60, the interpolation circuit 34 converts the RGB value of the input image signal thus input into the RGB value corresponding to the output image signal to output the result to the light modulation section drive circuit 38 with reference to the grid-point group LG thus rewritten. FIG. 8 is an explanatory diagram schematically showing the display image in the state in which the color conversion process from the designated color C1 into the conversion color C2 is performed. As shown in FIG. 8, there is output the display image 60b in which the color conversion from the designated color C1 into the conversion color C2 is performed using the grid-point group LG thus rewritten.

As described hereinabove, according to the color conversion method in the present embodiment, by rewriting only a part of the correspondence relationship between the input image signal and the output image signal, only the arbitrary designated color C1 included in the display image is changed to the arbitrary conversion color C2. Therefore, it is possible for the user to arbitrarily convert some of the colors of the display image with a simple method without performing a process of a large amount of data such as rewriting of the entire conversion map.

According to the color conversion method related to the present embodiment, there is used the grid-point group LG determined in advance in the discretized state as the correspondence relationship between the input and output values of the image signal value. Thus, it is possible to constitute the correspondence relationship between the input image signal and the output image signal with a smaller amount of data, and at the same time, it is possible to simplify the process necessary for the color conversion.

### B. Second Embodiment

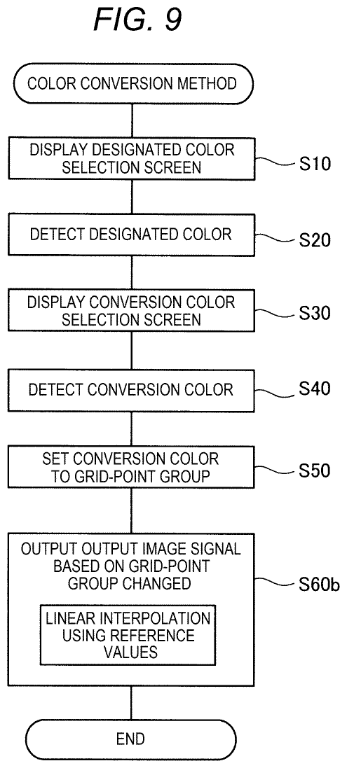

FIG. 9 is a flowchart showing a color conversion method according to a second embodiment to be performed by the simple color gamut conversion circuit 32. The color conversion method according to the second embodiment is different in the point that the step S60b is provided instead of the step S60 in the color conversion method according to the first embodiment, and the rest of the configuration is substantially the same as that in the first embodiment. In the step S60b, the interpolation circuit 34 further performs the color conversion process with the linear interpolation using the reference values Rf1, Rf2.

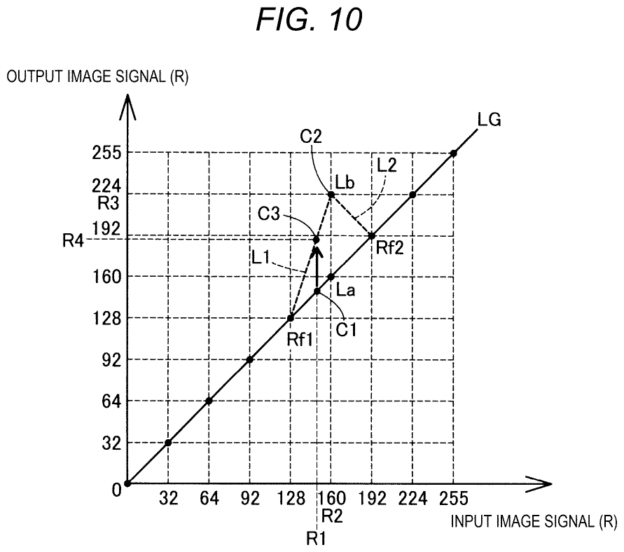

FIG. 10 is an explanatory diagram showing a correspondence relationship of a color conversion from the input image signal to the output image signal in the second embodiment. The interpolation circuit 34 performs a process of setting the conversion color C2 in the grid-point group LG similarly to the first embodiment, and at the same time, sets the reference values Rf1, Rf2 shown in FIG. 10. More specifically, the second nearest grid-point to the input pixel value R2 which is the nearest neighbor of the input pixel value R1 of the designated color C1 is set by the interpolation circuit 34 as the reference value Rf1, and the grid-point located on the opposite side to the reference value Rf1 with respect to the input pixel value R2 to be the nearest neighbor is set by the interpolation circuit 34 as the reference value Rf2. In other words, the grid-points located at the anterior position and the posterior position with respect to the input pixel value R2 to be the nearest neighbor of the designated color C1 out of the grid-point group LG are set by the interpolation circuit 34 as the respective reference values Rf1, Rf2.

In the present embodiment, when the input color including the R value which is not included in the grid-point group LG in the vicinity of the input pixel value R2 is input as the input image signal, the interpolation circuit 34 performs the color conversion process using the linear interpolation. More specifically, the color conversion with the linear interpolation using the output pixel value R3 of the conversion color C2 and the reference value Rf1 is performed on the R value between the input pixel value R2 as the grid-point to be the nearest neighbor of the designated color C1 and the reference value Rf1, namely the designated color C1 including the R value not included in the grid-point group LG. The correspondence relationship of the color conversion represented by the interpolation process is conceptually shown in FIG. 10 as a straight line L1. In the example shown in FIG. 10, the input image signal including the input pixel value R1 is converted into an output pixel value R4 included in the straight line L1 by the interpolation process of the interpolation circuit 34. The color C3 including the output pixel value R4 is also referred to as an interpolation conversion color C3. Similarly, the color conversion process with the linear interpolation using the output pixel value R3 and the reference value Rf2 is preformed by the interpolation circuit 34 on the input color including the R value not included in the grid-point group LG between the input pixel value R2 and the reference value Rf2. Similarly to the straight line L1, a straight line L2 conceptually represents the correspondence relationship due to the linear interpolation using the reference value Rf2 and the input pixel value R2. As described above, even when there is input the input image signal including the R value not included in the grid-point group LG from the reference value Rf1 through the reference value Rf2, the interpolation circuit 34 performs the color conversion process of performing the conversion into the color on the straight lines L1, L2 with the interpolation process.

According to the color conversion method related to the present embodiment, there is performed the process of performing the color conversion on the color in the vicinity of the designated color C1 not included in the grid-points of the grid-point group LG with an interpolation calculation using the grid-point group LG to be the neighbor of the designated color C1 as the reference value Rf1. Thus, it is possible to perform the color conversion on the input color not included in the grid-point group LG with the simple method. For example, even when performing the color conversion on a gradation image including the designated color C1 not included in the grid-point group LG, it is possible to express the gradation with the display image on which the color conversion has been performed.

### C. Other Embodiments

(C1) Although the RGB value on the grid-point is used for the color conversion process by the interpolation circuit 34 of the simple color gamut conversion circuit 32 in the embodiments described above, the RGB value on the grid-point is not a limitation, and it is also possible to perform the color conversion process using any of the RGB values expressed in, for example, 0 through 255 gray levels. Even in such a configuration, it is possible to simply convert only the designated color into the conversion color by rewriting a part of the correspondence relationship between the input image signal and the output image signal.

(C2) Although there is shown the example of selecting the conversion color C2 having the R value included in the grid-point in the three-dimensional color space in the selection of the conversion color C2 by the user in each of the embodiments described above, it is also possible to select a color having the R value other than the grid-points in the three-dimensional color space as the conversion color C2. In this case, the color in which the R value not included in the grid-point is approximated to the R value on the grid-point to be the nearest neighbor of the R value not included in the grid-point can be set as the conversion color. It is also possible to adopt a configuration in which only the colors on the grid-points are selected as the conversion color from the color pallet constituted by the colors set only by the RGB values on the grid-points in the three-dimensional color space.

### D. Other Aspects

The present disclosure is not limited to the embodiments described above, but can be implemented in a variety of aspects within the scope or the spirit of the present disclosure. For example, the present disclosure can also be implemented in the following aspects. The technical features in each of the embodiments described above corresponding to the technical features in each of the aspects described below can arbitrarily be replaced or combined in order to solve a part or the whole of the problem of the present disclosure, or to achieve some or all of the advantages of the present disclosure. Further, the technical feature can arbitrarily be eliminated unless described in the present specification as an essential element.

(1) According to an aspect of the present disclosure, there is provided a color conversion method. The color conversion method may include the steps of taking a color required to be changed as a designated color out of input colors included in a display image to be displayed using an input image signal, taking a conversion color to be designated as an output color after changing the designated color, and performing color conversion of the designated color into the conversion color out of the input colors to output an output image signal for displaying the display image using the input image signal on which the color conversion was performed. According to the color conversion method of this aspect, the color conversion into the conversion color is performed only on the designated color using the input image signal. Therefore, it is possible to arbitrarily convert some of the colors of the display image with a simple method without performing a process of a large amount of data such as rewriting of the entire conversion map.

(2) In the color conversion method according to the above aspect, there may further be included the steps of performing the color conversion using a grid-point group determined in advance out of a plurality of grid-points defining an output color corresponding to the input color, approximating the designated color to a grid-point nearest neighbor of the designated color out of the grid-points included in the grid-point group, making the conversion color correspond to another grid-point not included in the grid-point group, and constituting the grid-point group by the another grid-point instead of the nearest neighbor grid-point approximated. According to the color conversion method of this aspect, since the color conversion from the designated color to the conversion color is performed using the input image signal using the grid-point determined in advance, the correspondence relationship of the conversion from the input image signal to the output image signal can be constituted with a small amount of data, and at the same time, the process necessary for the color conversion can be simplified.

(3) In the color conversion method according to the above aspect, there may further be included the steps of setting a second nearest grid-point to the nearest neighbor grid-point of the designated color as a reference value with respect to the designated color out of the grid-point group, and converting the designated color into an interpolation conversion color as the conversion color, the interpolation conversion color including a pixel value obtained by performing interpolation using a pixel value of the conversion color and the reference value, when taking a color including a pixel value between the nearest neighbor grid-point of the designated color and the reference value as the designated color. According to the color conversion method of this aspect, the color conversion is performed on the color in the vicinity of the designated color not corresponding to the grid-point group with interpolation calculation using the grid-point group in the vicinity of the designated color as the reference value. Thus, it is possible to perform the color conversion on the input color not included in the grid-point group with the simple method. For example, even when performing the color conversion on a gradation image including the designated color not included in the grid-point group, it is possible to express the gradation with the display image on which the color conversion has been performed.

(4) In the color conversion method according to the above aspect, there may further be included the steps of displaying an adjustment screen including a selection screen for the designated color, and taking the designated color selected from the adjustment screen. According to the color conversion method of this aspect, it is possible for the user to select a color on the display image as the designated color while visually recognizing the color on the display image using the adjustment screen.

(5) In the color conversion method according to the above aspect, there may further be included the steps of displaying an adjustment screen including a selection screen for the conversion color, and taking the conversion color selected from the adjustment screen. According to the color conversion method of this aspect, it is possible for the user to select a color on the display image as the conversion color while visually recognizing the color on the display image using the adjustment screen.

(6) According to another aspect of the present disclosure, there is provided a display device. The display device includes a color conversion device including a color comparison circuit and an interpolation circuit, the color comparison circuit taking a color required to be changed as a designated color out of input colors included in a display image to be displayed using an input image signal, the interpolation circuit taking a conversion color designated as an output color after changing the designated color, performing color conversion of the designated color out of the input colors into the conversion color, and outputting an output image signal for displaying the display image using the input image signal on which the color conversion was performed, a control device configured to input the designated color and the conversion color to the color conversion device, and a projection device including a light modulation section and a projection optical system, the light modulation section modulating light emitted from a light source in accordance with the output image signal output from the color conversion device, the projection optical system collecting, diffusing, and then projecting the light modulated by the light modulation section.

The present disclosure can be put into practice in a variety of aspects other than the color conversion method and the display device. The present disclosure can be realized in the aspects of, for example, a color conversion device of performing the color conversion method according to the present disclosure, a method of controlling a color conversion device, a method of controlling a display device, a computer program for realizing the control method, and a non-temporary recording medium on which the computer program is recorded.

What is claimed is:

1. A color conversion method comprising:
taking a color required to be changed as a designated color out of input colors included in a display image to be displayed using an input image signal;
taking a conversion color to be designated as an output color after changing the designated color; and
performing color conversion of the designated color into the conversion color out of the input colors to output an output image signal for displaying the display image using the input image signal on which the color conversion was performed.

2. The color conversion method according to claim 1, further comprising:
performing the color conversion using a grid-point group determined in advance out of a plurality of grid-points defining an output color corresponding to the input color;
approximating the designated color to a grid-point nearest neighbor of the designated color out of the grid-points included in the grid-point group;
making the conversion color correspond to another grid-point not included in the grid-point group; and
constituting the grid-point group by the another grid-point instead of the nearest neighbor grid-point approximated.

3. The color conversion method according to claim 2, further comprising:
setting a second nearest grid-point to the nearest neighbor grid-point of the designated color as a reference value with respect to the designated color out of the grid-point group; and
converting the designated color into an interpolation conversion color as the conversion color, the interpolation conversion color including a pixel value obtained by performing interpolation using a pixel value of the conversion color and the reference value, when taking a color including a pixel value between the nearest neighbor grid-point of the designated color and the reference value as the designated color.

4. The color conversion method according to claim 1, further comprising:
displaying an adjustment screen including a selection screen for the designated color; and
taking the designated color selected from the adjustment screen.

5. The color conversion method according to claim 1, further comprising:
displaying an adjustment screen including a selection screen for the conversion color; and
taking the conversion color selected from the adjustment screen.

6. A color conversion device comprising:
a color comparison circuit configured to take a color required to be changed as a designated color out of input colors included in a display image to be displayed using an input image signal; and
an interpolation circuit configured to take a conversion color designated as an output color after changing the designated color, perform color conversion of the designated color out of the input colors into the conversion color, and output an output image signal for displaying the display image using the input image signal on which the color conversion was performed.

7. A display device comprising:
a color conversion device including a color comparison circuit and an interpolation circuit, the color comparison circuit taking a color required to be changed as a designated color out of input colors included in a display image to be displayed using an input image signal, the interpolation circuit taking a conversion color designated as an output color after changing the designated color, performing color conversion of the designated color out of the input colors into the conversion color, and outputting an output image signal for displaying the display image using the input image signal on which the color conversion was performed;
a control device configured to input the designated color and the conversion color to the color conversion device; and
a projection device including a light modulation section and a projection optical system, the light modulation section modulating light emitted from a light source in accordance with the output image signal output from the color conversion device, the projection optical system collecting, diffusing, and then projecting the light modulated by the light modulation section.

8. The display device according to claim 7, wherein
the projection device displays an adjustment screen including a selection screen for the designated color, and
the color conversion device takes the designated color selected from the adjustment screen.

9. The display device according to claim 7, wherein
the projection device displays an adjustment screen including a selection screen for the conversion color, and
the color conversion device takes the conversion color selected from the adjustment screen.
